(19) United States
(12) Patent Application Publication
(10) Pub. No.: US 2024/0037190 A1
(43) Pub. Date: Feb. 1, 2024

(54) MULTI-OUTPUT HEADED ENSEMBLES FOR PRODUCT CLASSIFICATION

(71) Applicant: RAKUTEN GROUP, INC., Tokyo (JP)

(72) Inventors: Hotaka SHIOKAWA, Tokyo (JP); Pradipto Das, Tokyo (JP)

(73) Assignee: RAKUTEN GROUP, INC., Tokyo (JP)

(21) Appl. No.: 17/872,211

(22) Filed: Jul. 25, 2022

(51) Int. Cl. G06K 9/62; G06N 3/08

(52) U.S. Cl. CPC G06K 9/6277; G06K 9/6262; G06N 3/08

(57) ABSTRACT

An item classification method and system using multi-output headed ensembles, that can include receiving one or more text input sequences at one or more first estimator threads corresponding to the one or more text input sequences. The method can also include tokenizing the one or more text input sequences into one or more first tokens within the one or more first estimator threads. In addition, the method can include outputting one or more item classifications based on an output of the one or more first estimator threads. Further, the method may include applying a backpropagation algorithm to update network weights connecting neural layers in the first estimator threads, defining an optimal setting of network parameters using cross-validation with respect to the first estimator threads, and mapping the one or more first tokens to an embedding space within the one or more first estimator threads.

### BACKGROUND

### Technical Field

The present disclosure described herein relates to product item classification for e-commerce catalogs.

### Background

This section is intended to introduce the reader to aspects of art that may be related to various aspects of the present disclosure described herein, which are described and/or claimed below. This discussion is believed to be helpful in providing the reader with background information to facilitate a better understanding of the various aspects of the present disclosure described herein. Accordingly, it should be understood that these statements are to be read in this light, and not as admissions of prior art.

Generally, taxonomy of e-commerce catalogs consists of thousands of genres having assigned items that are uploaded by merchants on a continuous basis. The genre assignments by merchants can often be wrong or incorrect but are treated as ground truth labels in automatically generated training sets, thus creating a feedback loop that can lead to poor model quality over time. The foregoing problem in taxonomy classification becomes highly pronounced due to the unavailability of sizable curated training sets. Under such a scenario, it is common to combine multiple classifiers to combat poor generalization performance from a single classifier.

In addition, other factors that contribute to the difficulty of product taxonomy classification in large-scale e-commerce catalogs include the following: 1) Continuous large-scale manual annotation is infeasible, and data augmentation, semi-supervised and few-shot learning do not provide any guarantees; 2) the efficacy of data augmentation and semi-supervised learning methods get severely limited in the presence of label noise, which in industrial settings can range around 15%, further identifying the nature of corruption in labels is non-trivial, and internal assessments revealing that the genre assignment error rate by merchants is around 20% for the large scale catalog with more than 13K leaf nodes in the product taxonomy; and 3) there is often an unknown covariate shift in the final evaluation dataset that consists of the Quality Assurance (QA) team's preferred ways of sampling items including those strategies that provide incentives to merchants.

Accordingly, what is needed is a more efficient, faster, and more accurate method of product taxonomy classification within catalogs, such as large-scale e-commerce catalogs. And more particularly, what is needed is a minimalistic neural network architecture that can take advantage of the reduction of estimator variance for ensembles and the advantages of fusing several classifiers.

### BRIEF SUMMARY

In one aspect of the disclosure described herein, a product item and taxonomy classification method and system, namely, a Multi-Output Headed Ensemble (MoHE) framework, is disclosed is efficient, effective, fast, accurate, and further utilizes minimum computing resources. In particular, the product item classification method and system of the disclosure described herein provides a lightweight and minimalistic neural network architecture that can take advantage of the reduction of estimator variance for ensembles and the advantages of fusing several classifiers, among other advantages. In addition, the MoHE framework system and method of the disclosure described herein is adaptable to include structured metadata, which can be difficult in conventional heavyweight language models such as BERT. In addition, the disclosure described herein provides a way of measuring label discrepancy between training and evaluation sets using user interactions with a product catalog.

In addition, an independent ensemble of classifiers often shows higher predictive variance while classifying out of sample items in a test set. This is generally because the independent classifiers have no way of exchanging each other's gradient information while optimizing for the same objective. Here, an MoHE-1 framework system and method of the disclosure described herein fixes this problem by both fusing the output layers of each individual classifiers while averaging the individual predictions of each classifier including the fusion or aggregator module. In addition, an MoHE-2 framework system and method of the disclosure described herein further adds a mini fusion module within each individual classifier.

In another aspect of the disclosure described herein, a highly flexible, scalable, and tunable framework is disclosed to add various “expert” classifiers, referred to herein as estimator threads, where individual estimator threads can also be added for various metadata fields. While most neural networks try to perform input representation learning without additional domain specific insights on the data, such as those reflected in the metadata, the MoHE framework system and method of the disclosure described herein re-enables such effort to be included within the neural modeling for better predictive accuracy.

In another aspect of the disclosure described herein, the MoHE framework system and method can be a loosely coupled ensemble framework, where each individual classifier's output is considered as a head. Here, each head computes the posterior class probabilities when the task being modeled is a classification task. In this framework, however, heads are generally defined at the output layer. The MoHE model of the disclosure described herein, as a statistical estimator, has lower variance than just an independent ensemble of classifiers. In particular, such as referring to FIGS. 4A-4B, tokenized text can be first converted into an embedding vector via embedding (EMB) modules, which is then encoded via encoder (ENC) modules using Convolutional Neural Networks (CNNs) with a dropout layer. Still referring to FIGS. 4A-4B, a layer normalizer (LayerNorm) can then be applied to the resulting vector from the encoder modules. The aggregator (AGG) network module accepts the concatenation of all such layer normalized vectors and is itself a feed forward neural network. Each classifier (CLF) module in FIGS. 4A-4B is also a feed forward neural network classifier. The CLF modules together with the AGG module in FIGS. 4A-4B constitute the heads of the MoHE model and framework system and method of the disclosure described herein. Still referring to FIGS. 4A-4B, the AGG module can act as a small fusion network within the MoHE framework. In addition, each stack of embeddings, encoder, layer normalizer and classifier can be referred to herein as an estimator thread. Here, the MoHE framework system and method of the disclosure described herein can correlate decisions from individual classifiers using an aggregator neural network (or aggregator module/function) to reduce prediction variance further than that obtained by using a classifier ensemble alone. Moreover, the MoHE framework is flexible enough to incorporate arbitrarily complex encoders and classifier heads depending on application and business needs. The MoHE framework also fixes the problem of having just one shared input for all estimator threads, which is the case for the MoE model (FIG. 3B), among other advantages.

In another aspect of the disclosure described herein, an item classification method using multi-output headed ensembles is disclosed. The method can include receiving one or more text input sequences at one or more first estimator threads corresponding to each of the one or more text input sequences; tokenizing each of the one or more text input sequences into one or more first tokens within each of the one or more first estimator threads; and outputting one or more item classifications based on an output of the one or more first estimator threads. The method can also include applying a backpropagation algorithm to update one or more network weights connecting one or more neural layers in each of the one or more first estimator threads; defining an optimal setting of network parameters using cross-validation with respect to each of the one or more first estimator threads; and mapping each of the one or more first tokens to an embedding space within each of the one or more first estimator threads. In addition, the method can include defining one or more hyper parameters using an efficient hyperparameter search technique with respect to each of the one or more first estimator threads. The method can also include tokenizing each of the one or more text input sequences into one or more second tokens within one or more second estimator threads corresponding to each of the second tokens. Further, the method can include determining one or more coordinates for each of the one or more second tokens within an embedding space of each of the one or more second estimator threads. The method can also include encoding the determined one or more coordinates for each of the one or more second tokens using one or more convolutional neural network (CNN) weights with a dropout layer, thereby resulting in one or more vectors with respect to each of the one or more second estimator threads.

In addition, the method can include applying a layer normalizer to the one or more vectors to normalize each of the one or more vectors within each of the one or more second estimator threads; and sending the normalized one or more vectors from each of the one or more second estimator threads to an aggregator. Further, the method can include calculating one or more posterior class probabilities for one or more output heads corresponding to each of the one or more second estimator threads. The method can also include obtaining one or more item classifications based on the one or more posterior class probabilities at each output head for each of the one or more second estimator threads. Here, the averaged or summed one or more posterior class probabilities at each output head can further include an output of the aggregator.

In another aspect of the disclosure described herein, an apparatus for classifying items using multi-output headed ensembles is disclosed. The apparatus can include a memory storage storing computer program code; and a processor communicatively coupled to the memory storage, wherein the processor is configured to execute the computer program code and cause the apparatus to receive one or more text input sequences at one or more first estimator threads corresponding to each of the one or more text input sequences; tokenize each of the one or more text input sequences into one or more first tokens within each of the one or more first estimator threads; output one or more item classifications based on an output of the one or more first estimator threads. In addition, the computer program code, when executed by the processor, further cause the apparatus to apply a backpropagation algorithm to update one or more network weights connecting one or more neural layers in each of the one or more first estimator threads; define an optimal setting of network parameters using cross-validation with respect to each of the one or more first estimator threads; and map each of the one or more first tokens to an embedding space within each of the one or more first estimator threads. Further, the computer program code, when executed by the processor, further cause the apparatus to define one or more hyper parameters using an efficient hyperparameter search technique with respect to each of the one or more first estimator threads. Also, the computer program code, when executed by the processor, further cause the apparatus to tokenize each of the one or more text input sequences into one or more second tokens within one or more second estimator threads corresponding to each of the second tokens. In addition, wherein the computer program code, when executed by the processor, further cause the apparatus to determine one or more coordinates for each of the one or more second tokens within an embedding space of each of the one or more second estimator threads.

The apparatus can further include wherein the computer program code, when executed by the processor, further cause the apparatus to encode the determined one or more coordinates for each of the one or more second tokens using one or more convolutional neural network (CNN) weights with a dropout layer, thereby resulting in one or more vectors with respect to each of the one or more second estimator threads. In addition, wherein the computer program code, when executed by the processor, further cause the apparatus to apply a layer normalizer to the one or more vectors to normalize each of the one or more vectors within each of the one or more second estimator threads; and send the normalized one or more vectors from each of the one or more second estimator threads to an aggregator. Further, wherein the computer program code, when executed by the processor, further cause the apparatus to calculate one or more posterior class probabilities for one or more output heads corresponding to each of the one or more second estimator threads. Also, the computer program code, when executed by the processor, further cause the apparatus to obtain the one or more item classifications based on the one or more posterior class probabilities at each output head for each of the one or more second estimator threads.

In another aspect of the disclosure described herein, a non-transitory computer-readable medium comprising computer program code for classifying items using multi-output headed ensembles by an apparatus is disclosed, wherein the computer program code, when executed by at least one processor of the apparatus, cause the apparatus to receive one or more text input sequences at one or more first estimator threads corresponding to each of the one or more text input sequences; tokenize each of the one or more text input sequences into one or more first tokens within each of the one or more first estimator threads; and output one or more item classifications based on an output of the one or more first estimator threads.

The above summary is not intended to describe each and every disclosed embodiment or every implementation of the disclosure. The Description that follows more particularly exemplifies the various illustrative embodiments.

### BRIEF DESCRIPTION OF THE DRAWINGS

The following description should be read with reference to the drawings, in which like elements in different drawings are numbered in like fashion. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1A illustrates a diagram for one non-limiting exemplary embodiment of a general simplified network architecture of the disclosure described herein.

FIG. 1B illustrates a block diagram for one non-limiting exemplary embodiment of a process flow of the disclosure described herein.

FIG. 2 illustrates a block diagram for one non-limiting exemplary embodiment of aggregator model.

FIG. 3A illustrates a block diagram for one non-limiting exemplary embodiment of an ensemble model.

FIG. 3B illustrates a block diagram for one non-limiting exemplary embodiment of a mixture of experts (MoE) model.

FIG. 4A illustrates a block diagram for one non-limiting exemplary embodiment of the multi-output head ensemble (MoHE-1) of the disclosure described herein.

FIG. 4B illustrates a block diagram for another non-limiting exemplary embodiment of the multi-output head ensemble (MoHE-2) of the disclosure described herein.

FIG. 5A illustrates a block diagram for another non-limiting exemplary embodiment of the multi-output head ensemble (MoHE-1, method-1) of the disclosure described herein having metadata estimator threads.

FIG. 5B illustrates a block diagram for another non-limiting exemplary embodiment of the multi-output head ensemble (MoHE-2, method-1) of the disclosure described herein having metadata estimator threads.

FIG. 5C illustrates a block diagram for another non-limiting exemplary embodiment of the multi-output head ensemble (MoHE-2, method-2) of the disclosure described herein having metadata estimator threads.

FIGS. 6A-7 illustrates various tables with respect to experimental testing data of the disclosure described herein.

FIGS. 8-10 illustrate various charts with respect the experimental testing data of the disclosure described herein.

FIGS. 11A-11C illustrate various tables with respect to the experimental testing data of the disclosure described herein.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a central database center and vice versa. The information may be stored in memory at each of the computing device, a data storage resided at the edge of the network, or on the servers at the central database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., an iPhone®, Android®, Blackberry®, or any “smart phone”), a personal computer, iPad®, server computer, or laptop computer; personal digital assistants (PDAs) such as an Android®-based device or Windows® device; a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including Bluetooth®, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer program code or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

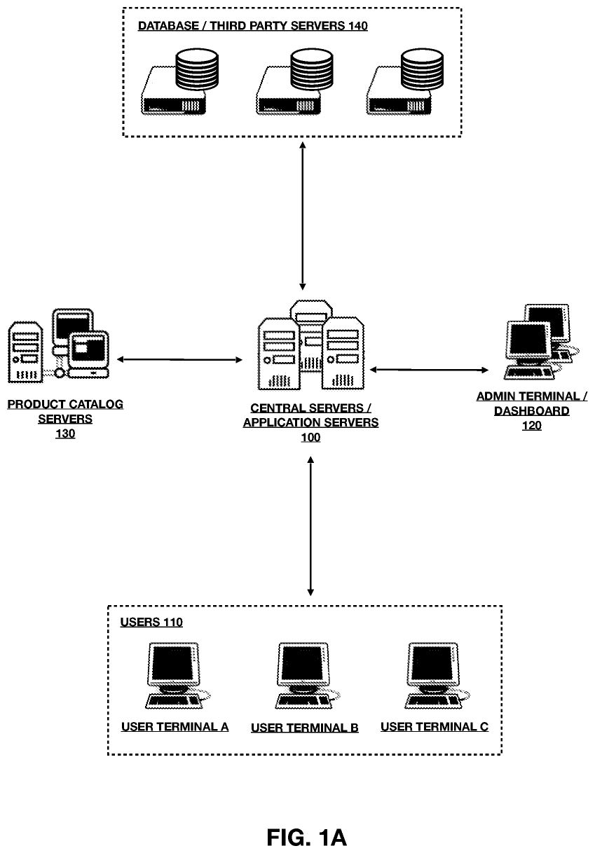

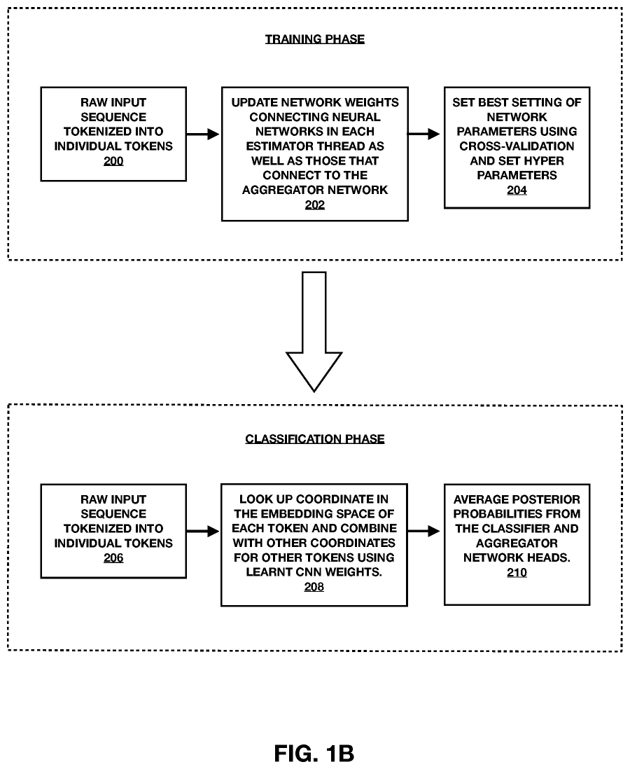

FIG. 1A illustrates one non-limiting exemplary embodiment of a general network architecture of the network services marketplace platform, process, computing device, apparatus, computer-readable medium, and system of the disclosure described herein. In particular, users 110, including user terminals A, B, and C, can be in bi-directional communication over a secure network with central servers or application servers 100 of the MoHE framework system and method of the disclosure described herein. Here, servers 100 can include one or more e-commerce websites or portals. In addition, users 110 may also be in direct bi-directional communication with each other via the MoHE framework system and method of the disclosure described herein. Here, users 110 may be any type of end user. Each of users 110 can communicate with servers 100 via their respective terminals or portals.

Still referring to FIG. 1A, central servers 100 of the MoHE framework system and method of the disclosure described herein can be in further bi-directional communication with admin terminal/dashboard 120. Here, admin terminal/dashboard 120 can provide various tools to a user to manage any back-end or back-office systems, servers, applications, processes, privileges, and various end users of the disclosure described herein, or communicate with any of users 110 and servers 100, 130, and 140. Central servers 100 may also be in bi-directional communication with that of product catalog servers 130, which can include various types of products items, product catalogs, and product taxonomy data. Further, central servers 100 of the disclosure described herein can be in further bi-directional communication with database/third party servers 140. Here, servers 140 can provide various types of data storage (such as cloud-based storage), web services, content creation tools, data streams, data feeds, and/or provide various types of third-party support services to central servers 100 of the MoHE framework system and method. However, it is contemplated within the scope of the present disclosure described herein that the MoHE framework system and method of the disclosure described herein can include any type of general network architecture.

Still referring to FIG. 1A, one or more of servers or terminals of elements 100-140 may include a personal computer (PC), a printed circuit board comprising a computing device, a minicomputer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1A, one or more servers, terminals, and users 100-140 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-140. For example, the bus may be a communication bus, a cross-over bar, a network, or the like. The bus may be implemented using single or multiple (two or more) connections between the set of components of one or more of servers or terminals of elements 100-140. The disclosure is not limited in this regard.

One or more of servers or terminals of elements 100-140 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-140 and/or of the set of components of one or more of servers or terminals of elements 100-140 (e.g., memory, storage component, input component, output component, communication interface, rendering component).

One or more of servers or terminals of elements 100-140 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-140 may store information and/or computer-readable instructions and/or code related to the operation and use of one or more of servers or terminals of elements 100-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-140 may further comprise an input component. The input component may include one or more components that permit one or more of servers and terminals 110-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-140 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-140 may further comprise a communication interface. The communication interface may include a receiver component, a transmitter component, and/or a transceiver component. The communication interface may enable one or more of servers or terminals of elements 100-140 to establish connections and/or transfer communications with other devices (e.g., a server, another device). The communications may be effected via a wired connection, a wireless connection, or a combination of wired and wireless connections. The communication interface may permit one or more of servers or terminals of elements 100-140 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as Flash-LinQ, WiMedia, Bluetooth®, ZigBee®, Wi-Fi, LTE, 5G, and the like. In other embodiments, the communication interface may include an Ethernet interface, an optical interface, a coaxial interface, an infrared interface, a radio frequency (RF) interface, or the like.

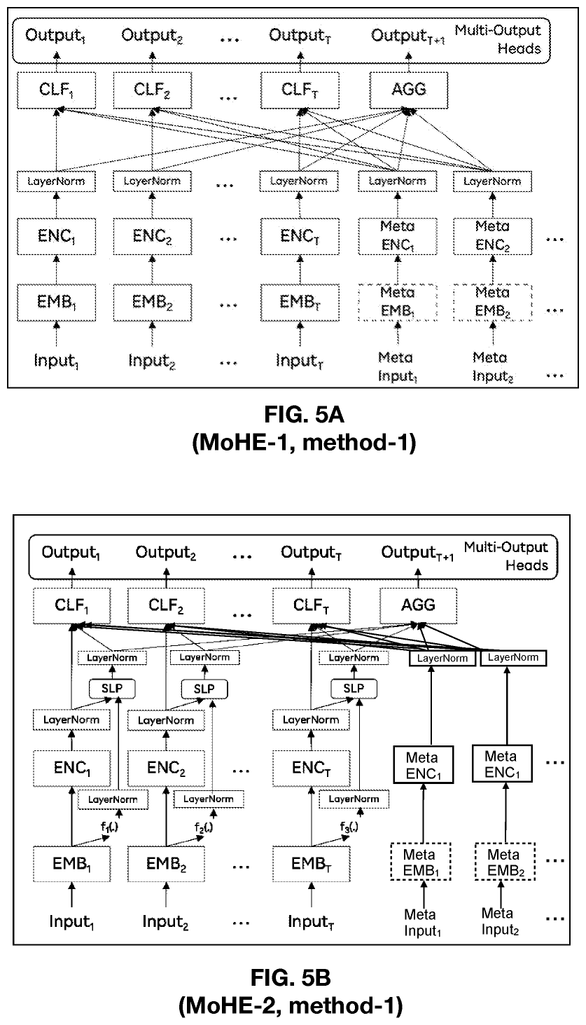

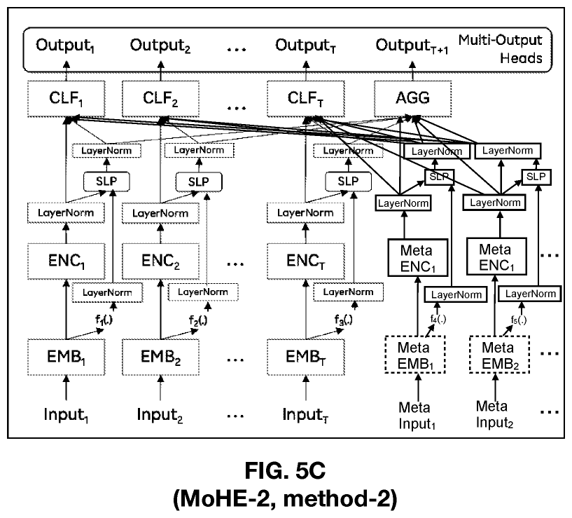

FIG. 1B illustrates one non-limiting exemplary embodiment of a process for the MoHE framework system and method of the disclosure described herein, which can include a training phase that is followed by a classification phase. With respect to the training phase, the process can begin at step 200, where one or more raw input sequences are first tokenized into individual tokens. Here, each estimator thread of the MoHE-1 or MoHE-2 models (FIGS. 4A and 4B) can accept different kinds of tokenized inputs. Here, each token in a particular input is mapped to a vector space of high dimension called the embedding space for the input. The process can then move to step 202, where the training happens by a standard backpropagation algorithm to update network weights connecting the neural layers in each estimator thread as well those that connect to the aggregator neural network. Here, the classification loss function applied at each output is the cross-entropy loss. The process can then move to step 204, where the best setting of network parameter parameters is set using cross-validation and hyper parameters are set using an efficient hyperparameter search technique. The process can then move to the classification phase, or step 206.

Still referring to FIG. 1B, at the classification phase, and at step 206, the process can first tokenize the raw input text sequence into individual tokens using the same mechanisms that was used during training (i.e., step 200). Here, the tokenized sequences are then fed or sent into the MoHE-1 or MoHE-2 models as inputs, as shown in FIGS. 4A and 4B. The process can then proceed to step 208. At step 208, corresponding to each token in the sequence input to each estimator thread, its coordinate in the embedding space (EMB), or vector space, is looked up and combined with other coordinates for the other tokens using learnt Convolutional Neural Network (CNN) weights. For each estimator thread and the aggregator network, the input embeddings are manipulated with the different weight parameters of the different neural layers in the network and the final posterior class probabilities for each head is computed. The process can then proceed to step 210, where the final classification is obtained by averaging or summing the posterior class probabilities from the classifier and aggregator network heads.

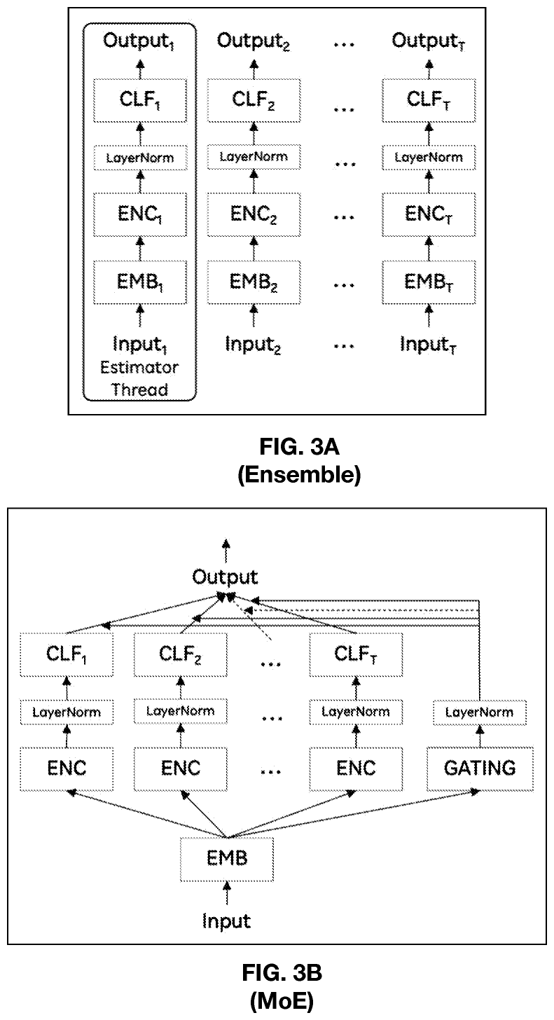

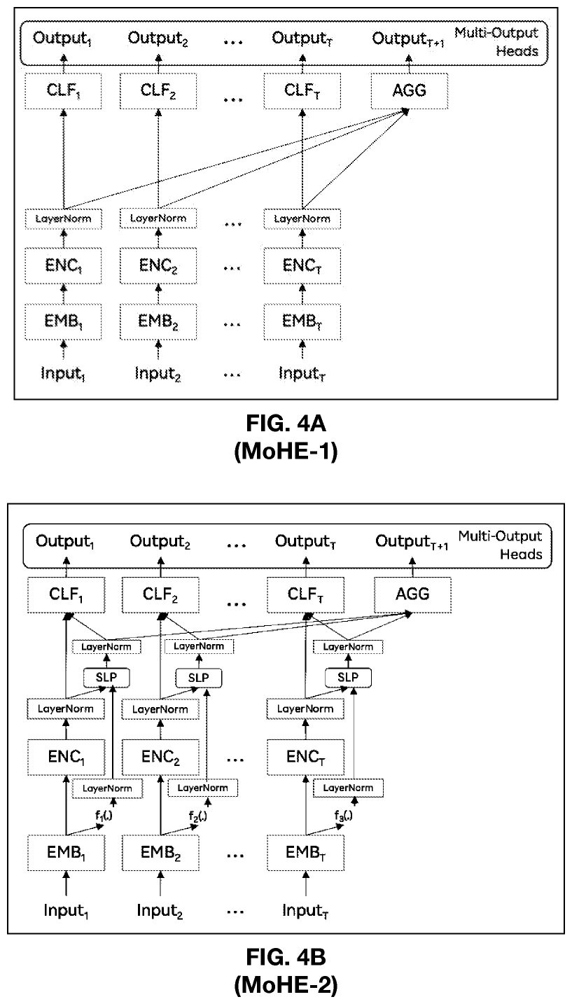

Here, the MoHE-1 model of the disclosure described herein with CNN encoders was observed to outperform the Mixture of Experts (MoE) model significantly on a classification task, which is to identify specific leaf level genres of items in a product catalog. The significant improvement was achieved on all segments of the catalog, namely, the head, torso and tail that constitute the top 70%, next 20%, and the final 10% of items by volume. In addition, the MoHE-1 model was observed to significantly outperform the Ensemble framework (FIG. 3A) in the head segment of the catalog where the data is more concentrated by volume.

In addition, in another non-limiting exemplary embodiment, a variation of the MoHE-1 model, referred to herein as MoHE-2 (FIG. 4B), was also shown to provide significant improvement over conventional models. In particular, the MoHE-2 model has additional neural layers to enhance the representational power of the input even more than MoHE-1. Here, MoHE-2 incorporates additional non-linearities within each estimator thread that act as a mini-aggregator network, which allows for the interaction of information geometries in two spaces, namely, a function of input's embedding (mean in the minimal framework) and input's encoding spaces.

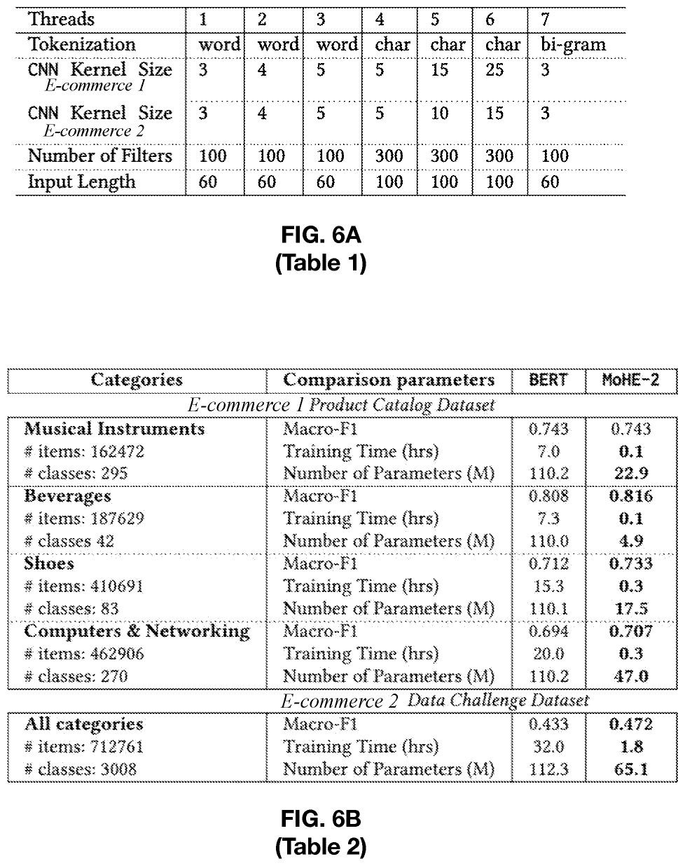

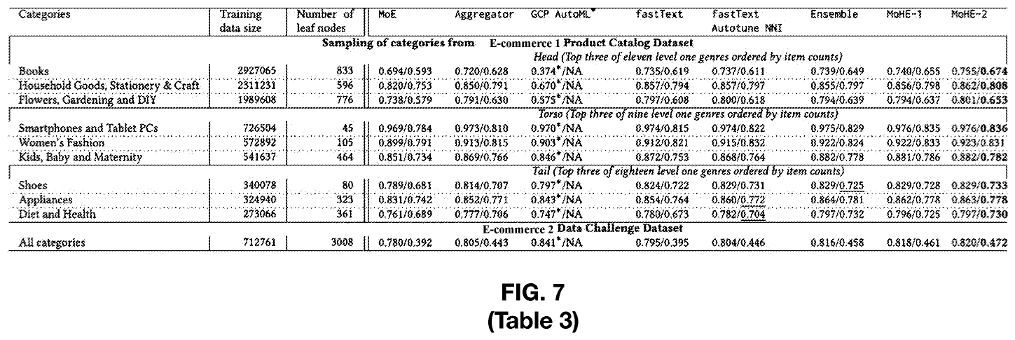

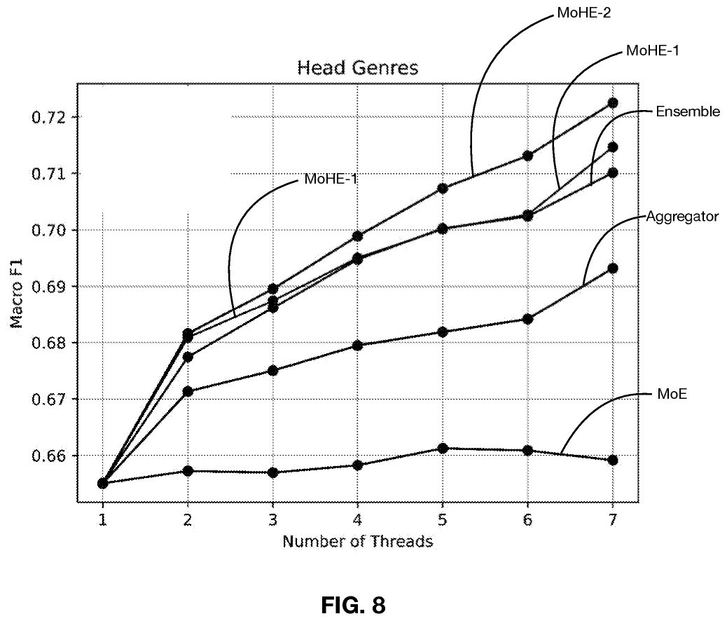

Further, in other embodiments, metadata can be incorporated into both the MoHE-1 and MoHE-2 models framework systems and methods of the disclosure described herein using method-1. In particular, additional estimator threads can be added to the MoHE model framework for each kind of metadata input. The output from each metadata encoder thread connects to all the classifier and aggregator neural layers. Here, the whole network can be trained on the training examples using standard backpropagation algorithm. This method of adding metadata to the MoHE-1 and MoHE-2 model frameworks has been referred to herein as method-1. For example, FIG. 5A illustrates method-1 as applied to the MoHE-1 model and FIG. 5B illustrates method-1 as applied to the MoHE-2 model.

In another embodiment of method-2 as applied to MoHE-2 shown in FIG. 5C, the output from each metadata estimator thread of the same type in method-1 can feed into all the Single Layer Perceptron (SLP) neural layers of each of the estimator threads for the primary inputs in the MoHE-2 model. This can be performed to have the metadata encodings add to the mini-aggregator network in each of the primary estimator threads. Also, with the addition of Merchant ID, Attribute Tag ID, and item descriptions, the MoHE-2 model with the second method (method-2) of incorporating metadata significantly outperforms all models compared here on both the head and torso segments of a tested E-commerce product catalog.

Generally, ensembles of independent estimators can generalize better than an individual estimator in that the variance of the ensemble estimator is better than the worse individual estimator. In particular, independent estimators T that estimate the posterior class probabilities by [symbol] (x), where [symbol] is the training dataset and x is any sample. The estimator with the worst variance gᵢ(x), for some i∈{1, . . . , T}, dropping the superscript [symbol] where dependence on [symbol] is assumed and let this variance be σ², the following can be represented (Equation 1):

$$Var ( \frac{1}{T} {\sum }_{t = 1}^{T} {g}_{t} ( x ) ) = \frac{1}{{T}^{2}} {\sum }_{t = 1}^{T} Var ( {g}_{t} ( x ) ) = \frac{1}{{T}^{2}} {\sum }_{t = 1}^{T} {σ}_{t}^{2} \leq \frac{1}{T} {σ}^{2}$$

The mixture of experts (“MoE”) model in the context of a neural network is a system of “expert(s)” and gating networks with a selector unit that acts as a multiplexer for stochastically selecting the prediction from best expert for a given task and input, such as shown in FIG. 3 of an MoE model. However, from a generalization point of view, the MoE classifier has a much looser bound than an ensemble of i.i.d. estimators. For example, if Eᵢₙ(g) denotes the in-sample (training) error and Eₒᵤₜ(g) denotes the out-of-sample (test) error, then using the union bound of probability, the following can be represented for MoE (Equation 2):

|Eᵢₙ(g)−Eₒᵤₜ(g)|>ϵ⇒|Eᵢₙ(g₁)−Eₒᵤₜ(g₁)|>ϵ . . . or |Eᵢₙ(g_{T})−Eₒᵤₜ(9_{T})|>ϵ

And applying the Hoeffding Inequality, the following can be represented (Equation 3):

$$P ( \vert {E}_{in} ( g ) - {E}_{out} ( g ) \vert > ϵ ) \leq {\sum }_{t = 1}^{T} P ( \vert {E}_{in} ( g ) - {E}_{out} ( g ) \vert > ϵ ) \leq 2 {Te}^{- 2 {ϵ}^{2} N}$$

Where N is the number of in-sample data points. Here, Equation 3 shows that generalization error bound for MoE can be loose by a factor of T.

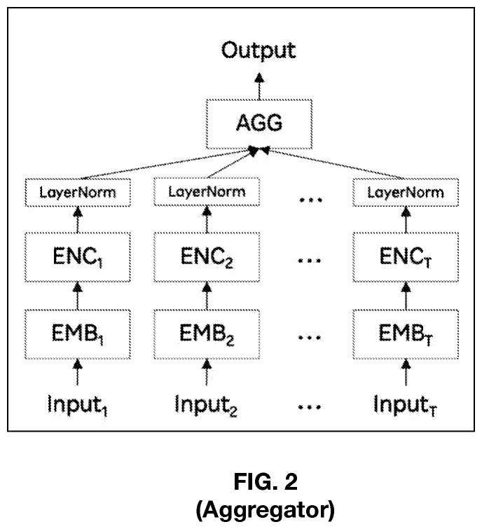

FIG. 2 illustrates one non-limiting exemplary embodiment of an aggregator framework with AGG as a “fusion” layer of the disclosure described herein. As shown, AGG does not share the inputs but shares the outputs from the encoders (ENC₁, ENC₂ . . . ENC_{T}) of the estimator threads. Here, the MoHE architecture of the disclosure described herein can be a coupled ensemble framework where each individual classifier's output can be considered as a head. Here, the heads can be defined only at the output layer, or the Multi-Output Heads (Output₁, Output₂ . . . Output_{T}, Output_{T+1}) as shown in FIG. 4A. In addition, as shown in FIG. 4A, any number of independent input-encoder-output units, which can be referred to as “estimator threads” or “threads,” are loosely coupled through an additional classification module which can be referred to as the aggregator. Here, the aggregator can perform the functions of a fusion module shown in FIG. 2. Here, each thread is allowed to have its own unique (and transformed) input, parameters, encoder, and output later for single task problems. The MoHE framework system and method of the disclosure described herein can be extended to handle multi-task problems.

Referring to FIGS. 4A-4B, the number of heads can be T+1 where T is the number is the number of threads (estimators) chosen by design and the additional one is for the aggregator that loosely couples the estimator threads. Here, posterior class probability estimates can then be obtained by either taking the output from the aggregator (such as shown in FIG. 2) or summing all (or part) of the output probabilities from the output heads of the estimator threads including the aggregator. Here, it has been observed that the latter typically outperforms the former except at early stages of the training or for small training datasets. In addition, the analysis for variance for the MoHE framework system and method of the disclosure described herein can be supported by distributional support. In particular, for each category k, the output vector from the heads and the aggregator, gₖ≡g, follows multivariate normal distribution. For a particular head t, the covariance and mean for g can be represented by the equation shown in FIG. 17A (Equation 4), as shown below:

$$g = [ \begin{matrix}{g}_{t} \\ {g}_{¬ t}\end{matrix} ] \sim N ( [ \begin{matrix}{μ}_{{g}_{t}} \\ {μ}_{{g}_{¬ t}}\end{matrix} ] , [ \begin{matrix}{\sum }_{{g}_{t} , {g}_{t}} & {\sum }_{{g}_{t} , {g}_{¬ t}} \\ {\sum }_{{g}_{¬ t} , {g}_{t}} & {\sum }_{{g}_{¬ t} , {g}_{¬ t}}\end{matrix} ] )$$

Where [symbol] is a T-dimensional vector and gₜ is a scalar for each class k. Under this, if all of [symbol] is fixed, then the following representation can be shown (Equation 5):

$${μ}_{{ℊ}_{t} \vert {g}_{¬ t} = {μ}_{{ℊ}_{t}} = {Σ}_{{ℊ}_{t , {ℊ}_{¬ t}}} {Σ}_{{ℊ}_{¬ t} , {ℊ}_{¬ t}}^{- 1} ( {g}_{¬ t} - {μ}_{{ℊ}_{¬ t}} )}$$

$${\sum }_{{ℊ}_{t} \vert {g}_{¬ t} = {\sum }_{{ℊ}_{t} , {ℊ}_{t}} - {\sum }_{{ℊ}_{t} , {g}_{¬ t}} {Σ}_{{g}_{¬ t} , {g}_{¬ t}}^{- 1} {\sum }_{{g}_{¬ t} , {ℊ}_{t}} {\sum }_{{ℊ}_{t} , {ℊ}_{t}} -}$$

In particular, [symbol] is positive definite (PD) since [symbol] is. This can be shown for an arbitrary PD matrix A and its eigenvalues Λ and eigenvectors V:

$$Av = {λ}_{vv} ⇒ \frac{1}{{λ}_{v}} v = {A}^{- 1} v$$

for λᵥ∈Λ and v∈V. Since [symbol] is PD and since [symbol] = [symbol] , hence by definition of positive definiteness that v^{T}Av [symbol] 0, there is a reduction of variance for each gₜ, t∈{1, . . . , T+1} and then the foregoing Equation 1 applies. Here, we note that in Equation 5, Σ_{g}_{ₜ}_{,g}_{ₜ}≡σ_{g}_{ₜ}² for fixed [symbol] .

Here, the MoHE framework system and method of the disclosure described herein can include encoder threads with arbitrary parameters and input tokenization. Here, the outputs from all encoders, also referred to herein as CNNs, can be globally max-pooled, concatenated, and given to the aggregator module, such as shown in FIG. 4A, for the baseline MoHE framework system and method, which may also be referred to herein as MoHE-1. Here, T can be defined to be the number of estimator threads, which can be, for instance, independent classifiers in the baseline ensemble framework, such as shown in FIG. 3A. Here, tokenized input text sequences, xₜ_{ᵢ}, which can be pre-processed differently for each thread so that xₜ_{ᵢ}≠xₜ_{ⱼ}, are converted to word embedding vector representations, vₜ∈R^{L}^{ₜ}^{×D}^{ₜ}, where Lₜ and Dₜ are the input text sequence length and embedding dimension, respectively. Accordingly, the following can be defined (Equation 6):

Vₜ=f_{t,1}(xₜ)=Dropout(Embedding(xₜ))

Where the second index in fₜ refers to the depth in the architecture of the estimator thread. Accordingly, the subsequence encoding can be represented by the following (Equation 7):

uₜ=f_{t,2}(Vₜ)=Dropout (GlobalMaxPool(CNNₜ(Vₜ)))

Where uₜ∈R^{P}^{ₜ} where Pₜ is the number of filters for CNNₜ. Accordingly, the estimator thread, t's output can be represented by the following (Equation 8):

gₜ=f_{t,3}(uₜ)=Softmax(CLFₜ(uₜ))

Where CLFₜ is a densely connected feed forward neural network (FFNN). Similarly, the output of the aggregator module can be represented by the following (Equation 9):

g_{T+1}=f_{T+1,3}({u_{t∈[1, . . . ,T]}})=Softmax(CLF_{T+1}(Concatenate(u_{t∈[1, . . . ,T]})))

In addition to the foregoing Equation 9, a layer normalization can be applied to uₜ to speed up the convergence and improve performance. Further, Dropouts can appear, as in Equations 6 and 7. In addition, contribution to the training loss function for a single data point can be represented by the following (Equation 10):

$$ℒ = {γ}_{T + 1} CE ( y , {g}_{T + 1} ) + {\sum }_{t = 1}^{T} {γ}_{t} CE ( y , {g}_{t} )$$

Where y is the one-hot representation of a label and γ_{T+1}+Σₜ₌₁^{T}γ₁=1 are tuning parameters. Here, the class posterior probabilities to be used for classification could be either g_{T+1} or

$$\frac{1}{T + 1} ( {g}_{T + 1} + {\sum }_{t = 1}^{T} {g}_{t} ) .$$

Here, the MoHE framework system and method can use the latter and further set γ_{T+1}=γₜ∀t, such as for the experimental data (to be discussed). Here, an Adam optimizer (except fastText) can be used for the MoHE framework system and method and not perform parameter tuning specific to each model or framework in order to focus on the effects of architectural variation.

In another non-limiting exemplary embodiment of the disclosure described herein, an MoHE-2 model or framework system and method may be used, such as shown in FIG. 4B. Here, the MoHE-2 framework system and method can incorporate additional non-linearities that can act as a mini-aggregator module that allows the interaction of information geometries in two spaces, which can be a function of input's embedding (mean in the minimal framework) and input encoding spaces. For the MoHE-2 framework, the Equation 8 can be represented by the following (Equation 11):

gₜ=Softmax(CLFₜ(SLP(Concatenate(uₜ,Vₜ))))

Where SLP is a single layer perceptron with tan h activations. In addition, Equation 9 can also be changed accordingly for the MoHE-2 framework. In particular, Dropouts can appear after (LayerNorm←fₜ(·)) and (LayerNorm←ENCₜ stacks. Here, CNN can be used as the encoder within the disclosure described herein, however, it is contemplated within the scope of the present disclosure described herein that it can be replaced with other encoders such as RNNs, LSTMs, or transformers, among others. In addition, for the experimental data (to be discussed), seven estimator threads and one aggregator module are used for exemplary purposes. However, it is contemplated within the scope of the present disclosure described herein that any number of estimator threads and aggregator modules may be used.

FIGS. 5A-5C illustrate non-limiting exemplary embodiments of the threads on a right of the estimator thread T that can be “meta estimator threads” which take as input any desired metadata referred to herein as Meta Input. Here, at least one advantage of the MoHE framework system and method of the disclosure described herein can be its ability to accept domain knowledge as additional metadata. The MoHE framework system and method can add new estimator threads corresponding to individual or multiple metadata fields, thereby preserving the structure of the data. On the other hand, if rich meta-data is appended to the main text, forming another longer text sequence, as is the case for fastText, then it can lead to loss of structure and strong coupling of meta-data parameters. Accordingly, the MoHE framework of the disclosure described herein can receive auxiliary information, or the products' metadata in two different ways or two different methods. The first method, which is referred to herein as method-1 as applied to MoHE-1, is shown in FIG. 5A. For the MoHE-1 model for method-1, the meta-data inputs are embedded, encoded, and the encodings concatenated with the inputs to all classifiers (CLF layers) including the aggregator module (AGG). Here, Multiple types of metadata can be given to a single metadata estimator thread or to separate metadata estimator threads depending on the data and/or encoder types. The second method, which is referred to herein as method-2 as applied to MoHE-2, is shown in FIG. 5C. For the MoHE-2 model for method-2, the metadata threads can be identical to that of MoHE-1 with the exception of their outputs being given to SLPs in the MoHE-2 model, instead of directly to the classifiers. Here, the aggregator module does not take any input from the metadata threads in this case. Accordingly, the system and method of the disclosure described herein can employ basic text (one-dimensional) CNNs with a kernel size of one for the metadata encoders.

For the experimental data with respect to any of the foregoing models for the MoHE framework, such as MoHE-1 and MoHE2, the metadata or features that used appear only in one of the datasets, namely, a large scale Japanese product catalog (E-commerce 1), for exemplary purposes. Here, for the experimental data, there are multiple metadata values available for each item, such as various identification numbers related to the products, description, price, tags, image URLs, etc. For example, many merchant/shops sell products in only certain categories, and there “shop_ID” can be a strong feature for label correlation. A similar signal can be “tag_ID,” which can refer to an attribute type of a product. Within the experimental testing of the disclosure described herein, the maker/brand and shop tags are used as features and descriptions as another metadata feature.

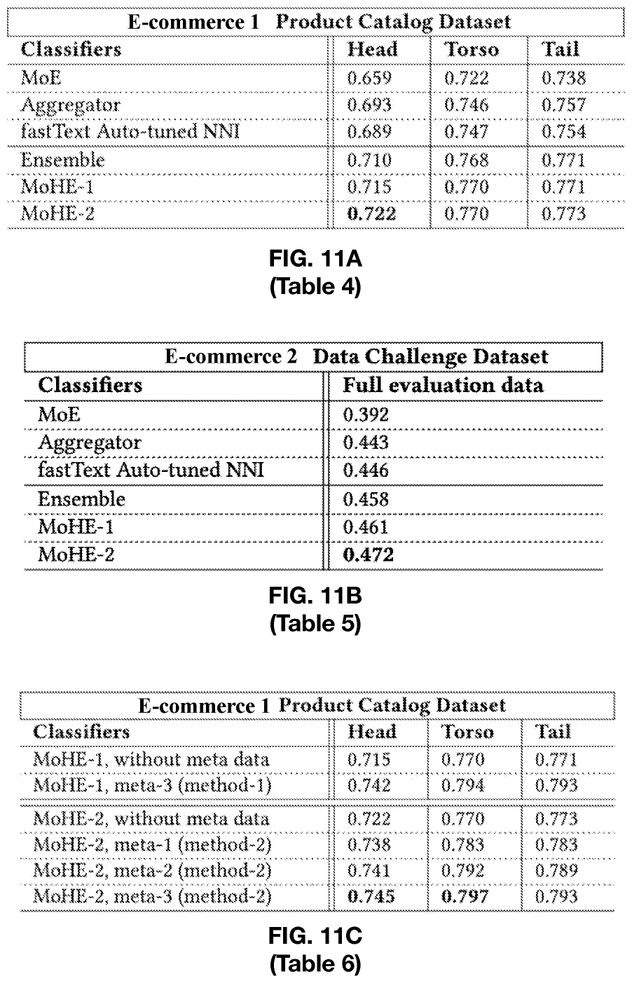

As previously disclosed herein, the meta estimator threads employ CNNs with kernel sizes of one as their encoders, so as to make them serve as keyword finders. For “descriptions,” however, the nouns, adjectives, and adverbs, and omitted repeating words are kept. The descriptions can therefor be a sequence of part-of-speech tagged tokens and the window size is set to one as well. This “feature engineering” of description fits long sentences within a maximum length≤120. In addition, a tokenizer is used for tokenizing and extracting parts of speech from Japanese product titles and descriptions. Accordingly, the Table 1 of FIG. 11C shows that using metadata for the MoHE-1 and MoHE-2 models, performance on the validation set improves by 3% absolute in macro F1 scores.

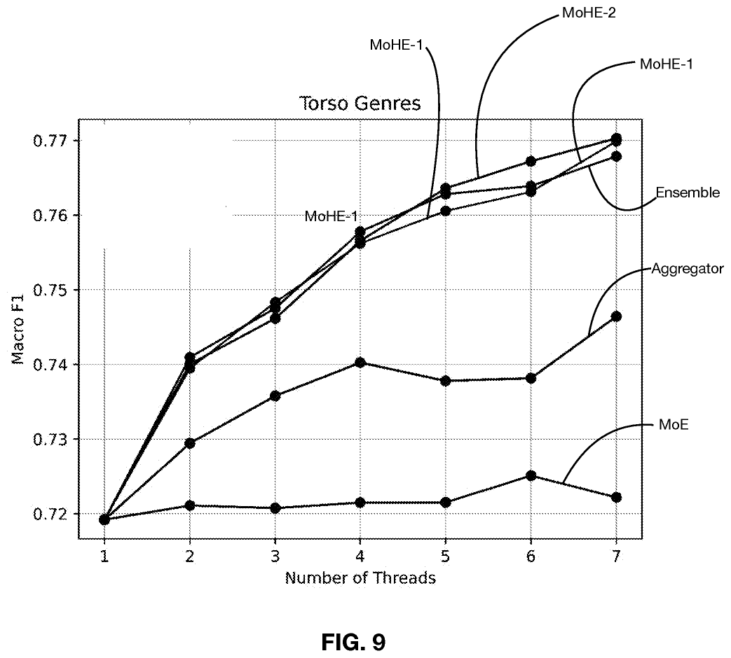

Table 1 of FIG. 6A illustrates baseline thread parameters for the experimental test. Here, the thread indices are ordered from left to right, such as shown in FIGS. 4A-5C. Further, the input sequence lengths are set to 60 for word based tokenization and 100 for character based tokenization since greater than 90% of titles of shorter than 60 words and 100 characters in length. Still referring to FIG. 6A, for the E-commerce 2 dataset, the default settings of CNN Kernel sizes for character tokenization are small than for E-commerce 1 since the average length of English words are ≈5 characters and sequential multiples of 5 were used. Further, “bi-grams” is by tokens.

In addition, for all of the experimental tests, the E-commerce 1 dataset was partitioned into training, development, and validation sets, all of which are sampled from the same data distribution. This distribution of items have no sampling bias in terms of purchase behavior and includes a large sample of items from purchased and non-purchased items and a minor percentage of historical curated items whose genres have been manually corrected. The data has noisy labels to the extent of 20% based on internal assessment. Further, a sample of genres was used based on purchased items from user sessions to validate this 20% figure. In addition, a non-overlapping evaluation set for the E-commerce 1 dataset was used, where annotators have sampled items based Gross Merchandise Sale (GMS) values and corrected mis-predicted genres from a previous model. However, for the experiments with the E-commerce 1 dataset, the validation set for model comparison was used. For the E-commerce 2 dataset, the challenge set was set to 200K items.

With respect to configurations for the MoHE threads, each estimator thread t is an embedding, encoder, and classifier stack with output later gₜ, which can be represented by the following:

gₜ=CLF_{t,3}(LayerNOrm(ENC_{t,2}(EMB_{t,1}(x))))

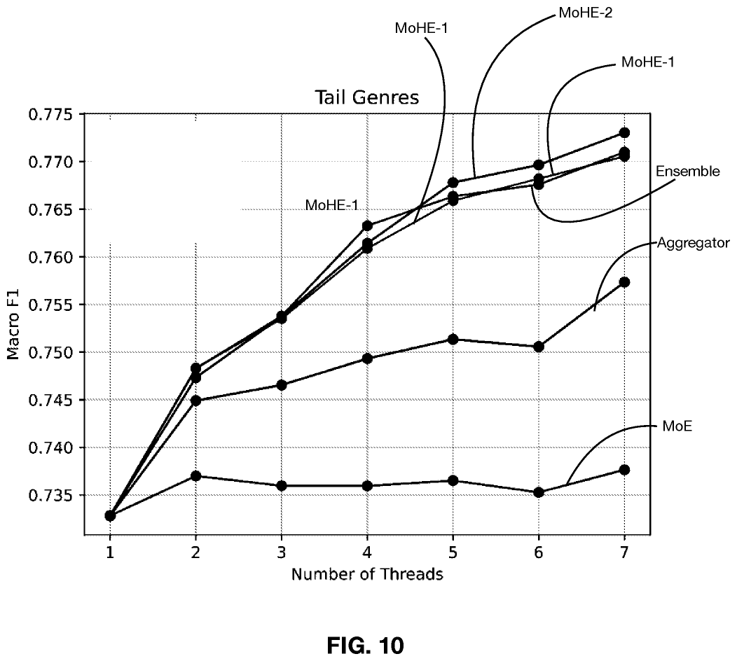

Here, each thread has different parameters and input tokenization types as summarized in Table 1 of FIG. 6A. Further, the parameter values are obtained using minimal manual tuning over a development set for the Ensemble model. Here, the word embedding dimension is set to

$$min ( \frac{C}{2} , 100 )$$

where C is the number of leaf nodes for each level one genre. This setting substantially reduces the number of parameters. Further, this embedding dimension is set for every model framework except fastText NNI and GCP AutoML. Finally, the dropout values are set to 0.1. Further, incrementally adding seven estimator threads to all models were experimented with, with the results shown in FIGS. 8-10. Here, the baseline configurations are used for building models for both E-commerce 1 and E-commerce 2 datasets. For these experiments, the parameters/properties of the estimator threads were not tuned. However, it is contemplated within the scope of the present disclosure described herein that tuning may also be performed.

For the experimental tests and evaluation of the MoHE framework of the disclosure described herein, Macro-F1 scores are used which induce equal weighting of genre performance and hence are a much stricter standard than other types of scores. In addition, for all models except AutoML and fastText NNI, the scores reported are averages of five runs. It is noted that the Ensemble of the disclosure described herein of CNNs base (i.e., MoHE without the coupling) is a strong classifier and significantly outperforms the MoE (FIG. 3B) and Aggregator baselines. Further, MoHE-2 was observed to significantly outperform Ensemble on the validation set.

For the experimental testing, a BERT model as compared to the MoHE-2 model of the disclosure described herein was used for a preliminary comparison on randomly selected 10% of level one genres from the E-commerce 1 dataset and all genres from the E-commerce 2 dataset. Here, the BERT model can be the model disclosed within Jacob Devlin, Ming-Wei Chang, Kenton Lee, and Kristina Toutanova. 2019, BERT: Pre-training of Deep Bidirectional Transformers for Language Understanding, NAACL-HLT, Association for Computational Linguistics, 4171-4186. Table 2 of FIG. 6B illustrates the BERT v. MoHE-2 comparison on four (4) randomly selected L1 genres from the E-commerce 1 dataset and full E-commerce 2 dataset. Here, the bold values denote cases where MoHE-2 significantly outperformed BERT at a 95% confidence interval for bootstrap sampling, and for most genres along all aspects of Macro-F1, compute time, and model size. Here, one of the main drawbacks with the BERT model is that is a more generalized multi-task model where fine-tuning is dependent to specific objectives of next word prediction based on a suitably chosen context. For the case of classification of item titles, the Next Sentence Prediction (NSP) objective of BERT is irrelevant if the disclosure described herein is to even pre-train on item titles.

The experimental testing using the MoHE framework system and method of the disclosure described herein can start with analyzing the importance of adding successive estimator threads to the different models and compare the graphs in the three plots shown in FIGS. 8, 9, and 10. In particular, FIGS. 8, 9, and 10 illustrate plots of Macro-F1 values for the MoE, Aggregator, Ensemble, MoHE-1, and MoHE-2 models from level one genre path classifiers for the E-commerce 1 dataset. Here, the leaf nodes for classification correspond to the level one genres, which are organized into head, torso, and tail segments. Overall, there are 38 level one genres and hence 38 groups of level one classifiers. Here, each of the 38 groups represents a set of estimator threads corresponding to a particular classification framework. In particular, FIG. 8 illustrates Macro-F1 values plotted against the number of threads for the head genres. FIG. 9 illustrates Macro-F1 values plotted against the number of threads for the torso genres. FIG. 10 illustrates Macro-F1 values plotted against the number of threads for the tail genres.

As previously discussed, the MoE model is still a single classifier and has a loose generalization bound and performs worst among all the models compared. Further based on the MoE model, the testing uses only one type of input that is shared with the “experts” and the “gate” and further choose the configuration shown for estimator thread one in Table 1 of FIG. 6A. Because of this constraint, it also does not show much variation in performance since the estimator threads differ only in initialization of the input embedding. Here, MoE suffers from bias in input selection that may also explain its poor performance. The classification performance shown in FIGS. 8-10 with regards to Maco-F1 scores for the level one genre paths of the head segment is overwhelmingly dominated by the MoHE-2 model of the disclosure described herein. For the level one genre paths that belong to the torso and tail segments, MoHE-2 also outperform Ensemble at seven estimator threads. Further, the additional mini-aggregators introduced in MoHE-2 show improvements. In addition, classification using only the Aggregator module of the MoHE framework of the disclosure described herein was shown to be an improvement over the MoE model where all the “expert” decisions are fused.

Table 3 of FIG. 7 illustrates the comparisons of MoHE and MoE, Aggregator framework (FIG. 2), GCP, AutoML, fastText, fastText Autotuned with NNI, and the Ensemble framework. In particular, Table 3 of FIG. 7 illustrates baseline model performance comparisons (Micro-F1/Macro-F1) for the representative nine genres from the validation set. Here, GCP AutoML ignores rare categories while training. The support set for categories during its evaluation is thus smaller leading to higher Micro-F1 scores being reported by GCP AutoML. Further, the numbers in bold for the MoHE-2 column are statistically significant to both fastText Autotune NNI and Ensemble under Bootstrap Sampling test with 95% confidence interval. Further, it is noted that MoE, Aggregator, fastText, Ensemble, MoHE-1, and MoHE-2 are not tuned to individual genres. Still referring to Table 3 of FIG. 7, the level one genres are first sorted in descending order of item frequency and segment them into head, torso, and tail segments. Next, nine categories are chosen, with the largest three, each from head, torso, and tail segments. Next, GCP AutoML and fastText tuned with Microsoft's NNI are compared. The nine categories have been chosen to run GCP AutoML. Next, GCP AutoML is run for at most a day for each of the nine genres. Further, fastText Autotune was not found to be stable for the E-commerce 1 dataset. It is noted that GCP AutoML constrains the volume of data ingestion, including skipping rare categories thereby hindering a fair comparison. It also reports Micro-F1 scores in batch mode and obtaining Macro-F1 scores incur additional cost and thus they are not reported in Table 3 of FIG. 7. Hence, GCP AutoML is dropped from further comparisons.

During the experimental testing, it was observed that the MoHE frameworks of the disclosure described herein with the default settings (Table 1 of FIG. 6A) often perform better than other baselines despite the fact that they consist of lightweight CNN architectures without being tuned for a specific genre or dataset. The gains are obtained more for the head and torso genres and since the category imbalance were not specifically modeled, the performance on the tail categories are not significantly better to both fastText Autotune NNI and Ensemble but to the underlined one. The performance of the MoHE-2 model is even better for the E-commerce 2 dataset that has much less label noise and lower number of classes.

The quantitative evaluations for the models can be summarized, such as the MoE, Aggregator, FastText AutoTune NNI, Ensemble, MoHE-1, and MoHE-2 models. The MoHE frameworks or models can be compared without adding metadata for the E-commerce 1 dataset to be fair to the E-commerce 2 dataset, which does not carry any metadata. Table 4 of FIG. 11A shows the comparative performance of the MoHE models against the baselines or other models. In particular, Table 4 of FIG. 11A illustrates Macro-F1 scores from the classifiers discussed herein on the validation set from the E-commerce 1 dataset. In particular, the MoHE-2 model framework performed the best. Table of FIG. 11B illustrates Macro-F1 scores from the models and frameworks discussed herein for the test from the E-commerce 2 dataset. For obtaining results from the E-commerce 2 dataset, as shown in Table 5 of FIG. 11A, the classifiers were set up as flat classifiers. In this case as well, the MoHE-2 model of the disclosure described herein outperformed all other models and frameworks. It is noted that in Table 3 of FIG. 7, GCP AutoML shows the highest Micro-F1 for this dataset due to a smaller support set.

Next, the MoHE framework system and method of the disclosure described herein can be compared with and without the use of metadata features. In particular, Table 6 of FIG. 11C illustrates Macro-F1 values for the MoHE-1 and MoHE-2 classifiers without and with metadata for level one genres in the validation set. Further, notations for the added meta data values are meta-1 (shop_ID_, meta-2 (shop_ID+tag_ID), and meta-3 (shop_ID+tag_ID+description). As previously noted, method-1 and method-2 are two different ways of adding metadata to the MoHE frameworks. Based on ablation studies shown in Table 6 of FIG. 11C, both “shop_ID” and “tag_ID” turn out to have strong correlations with labels. Effectiveness descriptions largely depends on genres, yet including tokens from descriptions with chosen parts of speech improves overall performance. By utilizing all three types of metadata, the largest level one genres gain 2-3% macro-F1 performance depending on the framework, and it has been observed that some of the tail genres gain more than 10%. Further, for exemplary purposes, the values for “shop_ID” and “tag_ID” were given to the same metadata thread while description was given to a separate metadata estimator thread. Table 6 of FIG. 11C illustrates that for all head, torso, and tail segments for L1 genres, MoHE-2, meta-3 (method-2) performs best although not statistically from MoHE-1, meta-3 (method-1) for the tail segment.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. An item classification method using multi-output headed ensembles, the method performed by at least one processor and comprising:
receiving one or more text input sequences at one or more first estimator threads corresponding to the one or more text input sequences;
tokenizing the one or more text input sequences into one or more first tokens within the one or more first estimator threads; and
outputting one or more item classifications based on an output of the one or more first estimator threads.

2. The method of claim 1, further comprising:
applying a backpropagation algorithm to update one or more network weights connecting one or more neural layers in the one or more first estimator threads;
defining an optimal setting of network parameters using cross-validation with respect to the one or more first estimator threads; and
mapping the one or more first tokens to an embedding space within the one or more first estimator threads.

3. The method of claim 1, further comprising:
defining one or more hyper parameters using an efficient hyperparameter search technique with respect to the one or more first estimator threads.

4. The method of claim 1, further comprising:
tokenizing the one or more text input sequences into one or more second tokens within one or more second estimator threads corresponding to the second tokens.

5. The method of claim 4, further comprising:
determining one or more coordinates for the one or more second tokens within an embedding space of the one or more second estimator threads.

6. The method of claim 5, further comprising:
encoding the determined one or more coordinates for the one or more second tokens using one or more convolutional neural network (CNN) weights with a dropout layer, thereby resulting in one or more vectors with respect to the one or more second estimator threads.

7. The method of claim 6, further comprising:
applying a layer normalizer to the one or more vectors to normalize the one or more vectors within the one or more second estimator threads; and
sending the normalized one or more vectors from the one or more second estimator threads to an aggregator.

8. The method of claim 7, further comprising:
calculating one or more posterior class probabilities for one or more output heads corresponding to the one or more second estimator threads.

9. The method of claim 8, further comprising:
obtaining the one or more item classifications based on the one or more posterior class probabilities at the output heads for the one or more second estimator threads.

10. The method of claim 9, wherein the one or more posterior class probabilities at the output heads further comprise an output of the aggregator.

11. An apparatus for classifying items using multi-output headed ensembles, the apparatus comprising:
a memory storage storing computer program code; and
at least one processor communicatively coupled to the memory storage, wherein the processor is configured to execute the computer program code and includes:
receive one or more text input sequences at one or more first estimator threads corresponding to the one or more text input sequences;
tokenize the one or more text input sequences into one or more first tokens within the one or more first estimator threads; and
output one or more item classifications based on an output of the one or more first estimator threads.

12. The apparatus of claim 11, wherein the computer program code, when executed by the processor, further causes the apparatus to:
apply a backpropagation algorithm to update one or more network weights connecting one or more neural layers in the one or more first estimator threads;
define an optimal setting of network parameters using cross-validation with respect to the one or more first estimator threads; and
map the one or more first tokens to an embedding space within the one or more first estimator threads.

13. The apparatus of claim 11, wherein the computer program code, when executed by the processor, further causes the apparatus to:
define one or more hyper parameters using an efficient hyperparameter search technique with respect to the one or more first estimator threads.

14. The apparatus of claim 11, wherein the computer program code, when executed by the processor, further causes the apparatus to:
tokenize the one or more text input sequences into one or more second tokens within one or more second estimator threads corresponding to the second tokens.

15. The apparatus of claim 14, wherein the computer program code, when executed by the processor, further causes the apparatus to:
determine one or more coordinates for the one or more second tokens within an embedding space of the one or more second estimator threads.

16. The apparatus of claim 15, wherein the computer program code, when executed by the processor, further causes the apparatus to:
encode the determined one or more coordinates for the one or more second tokens using one or more convolutional neural network (CNN) weights with a dropout layer, thereby resulting in one or more vectors with respect to the one or more second estimator threads.

17. The apparatus of claim 16, wherein the computer program code, when executed by the processor, further causes the apparatus to:
apply a layer normalizer to the one or more vectors to normalize the one or more vectors within the one or more second estimator threads; and
send the normalized one or more vectors from the one or more second estimator threads to an aggregator.

18. The apparatus of claim 17, wherein the computer program code, when executed by the processor, further causes the apparatus to:
calculate one or more posterior class probabilities for one or more output heads corresponding to the one or more second estimator threads.

19. The apparatus of claim 18, wherein the computer program code, when executed by the processor, further causes the apparatus to:
obtain the one or more item classifications based on the one or more posterior class probabilities at the output heads for the one or more second estimator threads.

20. A non-transitory computer-readable medium comprising computer program code for classifying items using multi-output headed ensembles by an apparatus, wherein the computer program code, when executed by at least one processor of the apparatus, cause the apparatus to:
receive one or more text input sequences at one or more first estimator threads corresponding to the one or more text input sequences;
tokenize the one or more text input sequences into one or more first tokens within the one or more first estimator threads; and
output one or more item classifications based on an output of the one or more first estimator threads.
